(19) United States
(12) Patent Application Publication
(10) Pub. No.: US 2017/0109955 A1
(43) Pub. Date: Apr. 20, 2017

(54) BLOCKCHAIN ELECTRONIC VOTING SYSTEM AND METHOD

(71) Applicant: Follow My Vote, Inc., Blacksburg, VA (US)

(72) Inventors: Adam Ernest, Blacksburg, VA (US); Nathan Hourt, Saint Louis, MO (US); Daniel Larimer, Christiansburg, VA (US)

(21) Appl. No.: 15/298,177

(22) Filed: Oct. 19, 2016

Related U.S. Application Data
(60) Provisional application No. 62/244,035, filed on Oct. 20, 2015.

(51) Int. Cl. G07C 13/00; H04L 9/30; H04L 9/32; H04L 9/06

(52) U.S. Cl. CPC G07C 13/00; H04L 9/0637; H04L 9/30; H04L 9/3247; G06Q 2230/00; G06Q 2220/00

(57) ABSTRACT

We provide a block-chain electronic election system comprising: an election admin client configured to administer an election; a voting client configured to electronically provide data for voter eligibility and voter decisions for one or more contests in the election; a voter identifier server configured to confirm or deny voter eligibility for submitting the voter decisions in the election; a registrar server configured to employ an automated process for disassociating personal identification information provided by the voter client from a public voter key; a blinded token for use in a voter registration process; and a block chain database configured to store election contest data and the voter decisions on the election contests, the voter decisions are cryptographically signed with the public voter key disassociated from the personal identification information provided by the voter client.

### CLAIM OF PRIORITY

The present application claims priority to and the benefit of the filing date of U.S. provisional application U.S. Ser. No. 62/244,035 filed on Oct. 20, 2015.

### TECHNICAL FIELD

The present application relates to an electronic voting system and method featuring a block chain database for the storage and auditing of votes.

### BACKGROUND

The growth of the Internet has fueled a technological revolution in the United States, but that revolution has largely left untouched elections for political office. The few locations that have welcomed technology have seen it underperform, leaving election divisions with electronic voting machines that are costly to maintain and vulnerable to cyberattacks. Even today only 28 states have implemented or are working to implement simple online voter registration. Holding elections is costly and time-consuming for voters and government alike; and yet, we hold so many of them that scholars have coined the term “voter fatigue” to describe the horrendous voter turnout and general lack of civic participation. Perhaps a cause of this public apathy is the opaqueness of the electoral system, which has undergone little change over the last century. Once their votes enter the “black box,” citizens have no choice but to trust that their election officials will handle their ballots with due solemnity and discretion.

Online voting technology could provide a solution to these problems while providing an ease in voting, but the technology must provide a robust and secure solution, especially considering the natural suspicion citizens may have concerning the integrity of an online voting system. Known systems embody basic data processing and natural procedures for electronic registration and voting, using well-known public key identification cryptographic systems. Known systems do not, however, provide a means to dissociate a voter's personal identification and qualification for voting from her ballot, nor do they provide a means for a voter to verify the vote she has cast well after casting her vote. These features would be a desirable part of an online voting system, because they would protect against the risks of vote buying and provide a way for a voter to audit her vote, two common risks associated with online voting systems.

### SUMMARY

In light of these problems, this application specifies a block chain electronic voting system and method that features an election admin client for administering an election; a voting client for electronically providing data for voter eligibility and voter decisions for the contests in the election; a voter identifier server for confirming or denying voter eligibility; a registrar server for employing an automated process for disassociating the personal identification information provided by a voter client from a public voter key; a blinded token for use in registration process; and a block chain database for storing election contest data and voter decisions on election contests, where the voter decisions are cryptographically signed with a public voter key disassociated from the personal identification information provided by a voter client. The block chain database includes data records associated with a particular election, including: (1) one or more contest records storing fields, names, and/or other criteria for a contest in a particular election; (2) a public key of one or more voter identifier servers and a public key of one or more registrar servers authorized to verify the eligibility of a specific voter client to submit a decision in an election; (3) an election definition record comprising data defining the contests in the election and groups of contests a particular voter client may be authorized for which to submit decisions.

In various examples, the voter client, voter identifier server, registrar server, and election admin client may all be any computing device or computing system, including a desktop computer, laptop computer, mobile phone, tablet, mobile device, server, or other computing device or system. The voter client is configured to provide to the voter identifier server personal identification information to confirm its eligibility to submit a request to vote to the registrar server, send a request to vote in an election to the registrar server, submit decision data if so eligible, and to access the data stored in the block chain database associated with the public voter key so that the voter client may audit the decisions it previously cast. The voter identifier server is configured to evaluate the personal identification information submitted by a voter client, and approve or disapprove a voter client's eligibility to submit specific decisions. The election admin client is configured to publish the election definition record for an election, and send the voter file to the voter identifier server.

In one or more examples of our system, the blockchain database contains data specifying which voter identifier servers and registrar servers are authorized to perform their functions within the system. This is accomplished by listing out the public key and IP address of each authorized server. A public key could be thought of as a nametag, instead of as a “key” that would allow the server to perform their role within the system. Each of these approved servers has its own unique public and private key pair (as used in public-key cryptography or asymmetric cryptography) that each uses to perform its roles within the system (i.e. cryptographically signing a transaction, such as asserting that a voter client is unique and eligible to vote in an election in the voter identifier server's case). Although the public key is the key that cryptographically signs the transaction, the private key is what the server uses to authorize the signing of the transaction. A server's private key is private and never known by any other server/client within the system.

### BRIEF DESCRIPTION OF THE DRAWINGS

Further features and advantages of the examples taught in the present application will become apparent from the following detailed description, taken in combination with the appended drawings, in which:

FIG. 1 is a diagram illustrating a block chain electronic voting system;

FIG. 2 is a diagram illustrating the process for a voter identifier client to verify the eligibility of a voter to cast a ballot;

FIG. 3 is a flowchart illustrating the election audit and tally process; and

### DETAILED DESCRIPTION

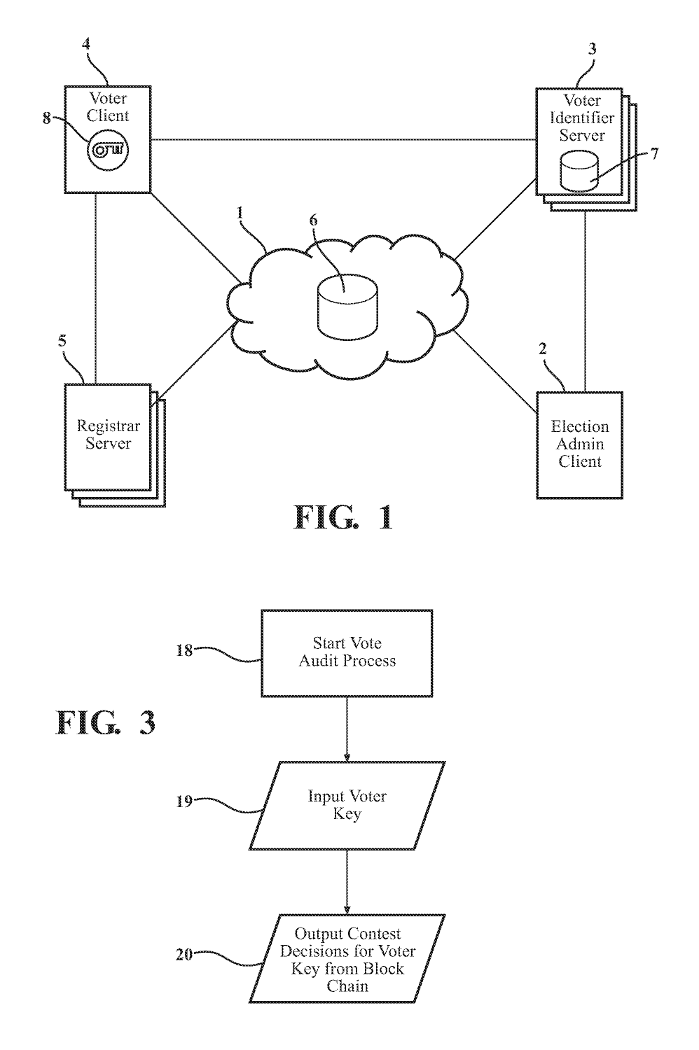

The present application provides a system and method for a block chain electronic voting system. The various examples described below are meant to teach by way of example only, with reference to FIGS. 1-3. Claimed subject matter is not so limited.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular voting methods taught herein. To this end, many well-known techniques and design choices are not repeated herein so as not to obscure the teachings of this disclosure.

Throughout this specification, the term system may, depending at least in part upon the particular context, be understood to include any method, process, apparatus, and/or other patentable subject matter that implements the subject matter disclosed herein. For example, unless specifically stated otherwise, as apparent from the following discussion, it is appreciated that throughout this specification a computing device includes, but is not limited to, a device such as a computer or a similar electronic computing device that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof.

We describe an internet-based system organized by a standard peer-to-peer architecture, setup by users that may download appropriate software to configure a computing device to adopt one or more particular functionalities described. It should also be understood that the system includes standard protocols for standard encryption and signature protocols for verifying system transactions.

Referring to FIG. 1, a block chain electronic voting system includes a block chain peer-to-peer network 1, an Election Admin Client 2, Voter Identifier Servers 3, a Voter Client 4, Registrar Servers 5, and a block chain database 6. Each client or server is a computing device that has hardware, software and/or firmware for communication across the Internet, an intranet, or any other manner of communication between such devices. A peer-to-peer network is a group of such computing devices, which communicate across any computer network. The block chain database 6 includes an election definition record from the Election Admin Client 2, the public key of the one or more Voter Identifier Servers 3 and the public key of the one or more Registrar Servers 5, and decisions from the Voter Client 4. The Voter Identifier Servers 3 each contain a Voter File 7 containing the list of registered voters and corresponding contest groups. It should be understood that the clients and servers 2, 3, 4, and 5, include other data storage typical of any computing device or system, and that each device may use such data storage, whether local or remote, to facilitate the functions they respectively carry out; as well as one or more CPUs or other processors and memory. Each of the clients 2 and 4 include typical hardware, software and/or firmware for input and output, e.g., a screen, mouse, keyboard, touchscreen, or other user interface, and also include standard communication hardware, software and/or firmware to communication with other computer devices, including a connection to the Internet or an intranet, and any known wireless or wired hardware to facilitate such communication. The block chain database 6 is organized based on a known method of data storage, such that the state of the database at a given time is computed by processing all prior database transactions since the empty state, in order, as they appear in blocks.

Utilizing standard cryptographic protocols and block chain transactions, an Election Admin Client 2 may publish an Election Definition Record on the block chain database 6 and thereby define a new election on the voting system, by defining Voter Identifier Server public keys and IP addresses, Registrar Server public keys and IP addresses, candidate names, party affiliation, criteria for voting for each office, and defining any other data an election might conceivably entail. The criteria may also define how many Vote Identifier Servers 3, if more than one exist in the system, must approve the personal identification information presented by a Voter Client 4 before the Voter Client 4 is authorized to register a Voter Public Key 8. The criteria may also define how many Registrar Servers 5, if more than one exist in the system, must approve the request for registration presented by a Voter Client 4 before the Voter Client's request is approved.

The voter client 4 is configured to publish a decision on an election contest to the block chain database 6, after first receiving authorization within the system as described above. Each Voter Identifier Server 3 facilitates this authorization by providing functionality and hardware configured to accept user input to provide a level of human verification. The Voter Identifier Server 3 may then approve the Voter Client 4 to register a Voter Public Key 8 to complete the authorization. If multiple Voter Identifier Servers 3 exist in the system, then the Voter Client 4 will receive approval to register only if the required number of Voter Identifier Servers 3 approve the Voter Client 4.

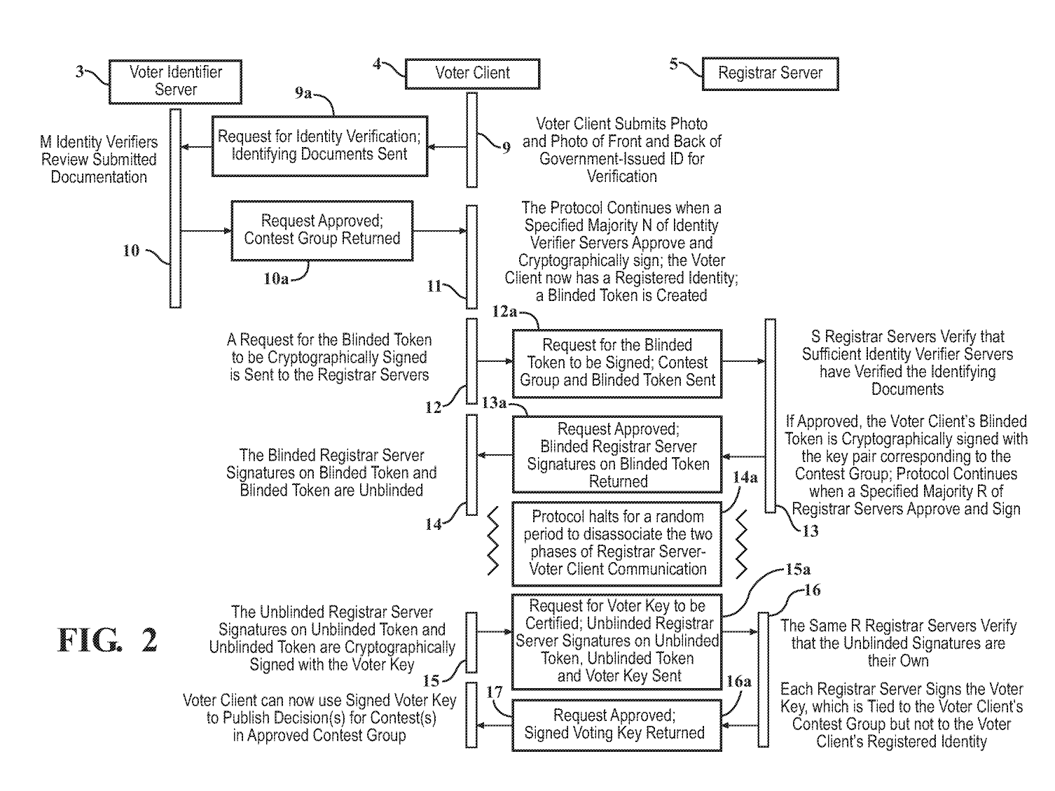

Referencing FIGS. 1 and 2 together, the system uses a specific protocol to approve a Voter Client 4 to submit decisions to the block chain database 6, and in the process disassociates the personal identifying information acquired in the voter identifier stage from the decision submission stage. FIG. 2 illustrates a process to document the identity of a user of Voter Client 4, thereby authorizing the Voter Client 4 to register a Voter Public Key 8. FIG. 2 further illustrates the process by which the Voter Client 4 requests a Voter Public Key 8 be registered by the Registrar Servers 5, thereby authorizing the Voter Public Key 8 to cryptographically sign decisions without connecting a Voter Public Key 8 with the personal identification information.

As illustrated in FIG. 2, potential voters in an election will be prompted through one or more Voter Clients 4 to use their webcams or mobile device cameras to take a photograph of themselves and of the front and back of their government-issued ID at block 9. The Voter Identifier Servers 3 are configured to specify which forms of identification to accept, which may or may not include driver's licenses, active duty and dependent military IDs, and passports. The system could be further expanded over time to accept other forms of identification, such as but not limited to finger print readers, retina scans, voice recognition or other technologies known now or in the future that may be used to verify an individual, as the online identity verification infrastructure improves. Claims are not intended to be limited to a particular document or biological voter verification technology.

Once the Voter Client 4 uploads three photographs (self, front of government-issued ID, back of government issued ID), the Voter Client 4 sends a request for identity verification to one or more Voter Identifier Servers 3. At block 10, each Voter Identifier Server 3 then determines whether the provided photographs are valid and the identified person is authorized to vote. Also before approving the request at block 11, the voter's physical address (as specified in the government-issued ID) will be indexed against a geographic information system (GIS) database in order to identify the contests for which she is eligible to participate in. Prior to the election, election officials will provide the GIS database to the Voter Identifier Servers 3. When a Voter Identifier Server 3 approves the request for identity verification, it certifies at block 11 that the Voter Client 4 is authorized to vote on a particular group of contests.

Looking at FIG. 2, once a sufficient majority of Voter Identifier Servers 3, as defined in the Election Definition Record in the block chain database 6, have certified that the Voter Client 4 is authorized to vote on a contest group at block 11, the Voter Client 4 proceeds to generate a blinded token at block 12 and submits this token to the Registrar Servers 5. Each Registrar Server 5 validates that the Voter Client 4 has been certified by a sufficient quorum of Voter Identifier Servers 3 and at block 13 returns a blinded cryptographic signature on the blinded token to the Voter Client 4. When a sufficient majority of Registrar Servers 5, as defined in the Election Definition Record in the block chain database 6, have returned blinded cryptographic signatures to the Voter Client 4, the Voter Client 4 unblinds the blinded signatures and blinded token at block 14.

In one or more examples, ballot anonymization is accomplished by the blinded token submission process. When submitting the blinded token to the Registrar Servers 5, the Voter Client 4 uses an Identity Key Pair to submit the request to sign the blinded token to the Registrar Servers 5, at which point their identity is known. When they receive the blinded token back with the Registrar Servers 5 blinded signatures on it, it is sent back to their Identity Public Key, which again is associated to their identity. Then the Voter Client 4 unblinds the blinded Registrar Server 5 signatures and blinded token. Then it uses the Voting Key Pair to submit a request for their Voter Public Key 8 to be certified to vote in the election, at which point the Voter Client's 4 identity is not associated to the Voter Public Key 8 (nor was it ever or will it ever be).

In one or more examples, the system waits a random period of time before proceeding to the next step of the protocol. After the random time delay, the Voter Client 4 generates a Voter Public Key 8 at block 15 and sends to each of the Registrar Servers 5 that returned blinded signatures the corresponding unblinded signature and unblinded token along with the Voter Public Key 8. Each Registrar Server 5 can verify its unblinded signature on the unblinded token to determine that it did approve of the request in block 13, but because the signature and token are now unblinded, the Registrar Server 5 is unable to determine exactly which Voter Client 4 this signature was in response to. Moreover, the random time delay prevents the Registrar Server 8 from using timing correlation to associate the request at block 15 with the request at block 12. The end result is that at block 16, the Registrar Server 5 can verify that the Voter Client 4 now requesting approval of a Voter Public Key 8 was one of the clients authorized at block 13, but the Registrar Server 5 is now unable to determine which client it was, thus disassociating the personal identification information from the Voter Public Key 8. The Registrar Server 5 certifies that the Voter Public Key 8 is authorized to vote on the appropriate contest group at block 16. When the Voter Client 4 has been approved by a quorum of Registrar Servers 5, it is able to publish decisions to the block chain database 6 cryptographically signed by its Voter Key 8 at block 17.

The random time delay may act to aid in ballot anonymization in scenarios such as if only one Voter Client 4 has (1) had identity verified, (2) registers to vote, and wants to (3) have its Voter Public Key 8 certified. A time delay may be included to ensure at least one other Voter Client 4 has gone through steps (1) and (2) before either can move on to step (3). IN this manner, ballot anonymization is preserved.

Once a Voter Client 4 has fully registered with the system, the voter may wish to revoke her access to vote online and so that she may vote at the central polling location. In this event, the Voter Client 4 will generate and cryptographically sign a transaction that revokes its Voter Public Key 8, so the signed transaction may be presented at the central polling location, where the Election Admin Client 2 is located. The Election Admin Client 2 also signs the transaction, and broadcasts it to the block chain 6, then issues a paper ballot, which the voter may use to vote in the traditional manner. The transaction revoking the Voter Public Key 8 signals to all clients and servers 2, 3, 4, and 5 in the system, as well as the block chain peer-to-peer network 1 to ignore any votes cast by the Voter Public Key 8 before or after this revocation, thus eliminating the possibility of a voter casting a counted vote both online and offline. Moreover, the voter cannot vote at a second polling location, as the revocation transaction is now invalid, and the Election Admin Client 8 will refuse to issue the voter a second ballot. In practice, the revocation transaction could be generated either at the polling place using a portable computing device functioning as a voter client 4, or at a non-portable computing device at the voter's home. The non-portable computing device would print out the revocation transaction on paper to be taken to the polling place, so the voter is not required to have a portable computer or phone. The voter could even print out the revocation transaction without having an active Internet or intranet connect′ on.

FIG. 3 illustrates the auditing process 18, which could be undertaken by any client or server 2, 3, 4, or 5, or any computing device in the block chain peer-to-peer network 1. A user would input their Voter Public Key 8 into the computing device in block 19, and the device would count and report the total tally of the contests, as well as the decisions published by the Voter Public Key 8 as they were counted in the tally, thus allowing the user to verify that the entire election was processed correctly, and that her decisions were accurately recorded and counted.

In the preceding description, various aspects of the electronic voting system and method have been described. For purposes of explanation, specific numbers, systems and/or configurations were set forth to provide a thorough understanding of the methods described herein. However, it should be apparent to one skilled in the art having the benefit of this disclosure that methods described herein may be practiced with other system components and/or architecture. Similarly, using the specific systems taught herein, other methods may be practiced within the scope and spirit of the electronic voting methods taught herein. In some instances, features that would be understood by one of ordinary skill were omitted or simplified so as not to obscure the disclosure. While certain features have been illustrated or described herein, many modifications, substitutions, changes or equivalents will now occur to those skilled in the art. It is, therefore, to be understood that claims are intended to cover all such modifications or changes as fall within the true spirit of claimed subject matter.

We claim:

1. A block-chain electronic election system comprising:
an election admin client configured to administer an election;
a voting client configured to electronically provide data for voter eligibility and voter decisions for one or more contests in the election;
a voter identifier server configured to confirm or deny voter eligibility for submitting the voter decisions in the election;
a registrar server configured to employ an automated process for disassociating personal identification information provided by the voter client from a public voter key;
a blinded token for use in a voter registration process; and
a block chain database configured to store election contest data and the voter decisions on the election contests, the voter decisions are cryptographically signed with the public voter key disassociated from the personal identification information provided by the voter client.

2. The system of claim 1, the block chain database comprising data records associated with the election, including: one or more contest records storing fields, names, and/or other criteria for the contest in the election; the public key of one or more of the voter identifier server and the public key of one or more of the registrar server authorized to verify the eligibility of the voter client to submit the voter decision in the election; an election definition record comprising data defining the contests in the election and groups of contests a particular voter client may be authorized for which to submit the decisions.

3. The system of claim 2, the election admin client configured to publish the election definition record for the election, and send the voter file to the voter identifier server.

4. The system of claim further comprising multiple voter clients, the system configured to manage multiple voter clients having differing voter eligibility for differing groups of contests the voter clients may submit the decisions in the election.

5. The system of claim 1, an election admin client configured to administer multiple elections.

6. The system of claim 1, the voter client configured to provide to the voter identifier server the personal identification information to confirm its eligibility to submit a request to vote to the registrar server, send a request to vote in the election to the registrar server, submit decision data if so eligible, and to access the data stored in the block chain database associated with the public voter key to audit the decisions it previously submitted.

7. The system of claim 1, the voter identifier server configured to evaluate the personal identification information submitted by the voter client, and approve or disapprove the voter client's eligibility to submit specific decisions.

8. A block chain electronic voting system comprising:
a block chain peer-to-peer network comprising a group of computing devices that communicate across a computer network;
an election admin client configured to define one or more elections;
one or more voter identifier servers each having a voter file comprising a list of registered voters and corresponding contest groups within which the registered voters are authorized to vote in the election;
one or more voter clients configured to present personal identification information to the vote identifier server and to present one or more decisions in the election;
the one or more voter identifier server configured to authorize the voter client to register a voter public key based at least in part upon the personal identification information;
one or more registrar servers configured to approve a request for registration presented by the voter client; and
a block chain database comprising an election definition record from the election admin client, one or more public keys of the one or more voter identifier servers and the public key of the one or more registrar servers, and decisions from the voter client.

9. The system of claim 8, the election admin client configured to utilize standard cryptographic protocols and block chain transactions, the election admin client configured to publish the election definition record to define a new election on the voting system by defining one or more voter identifier server public keys and IP addresses, one or more registrar server public keys and IP addresses, one or more candidate names, one or more party affiliations, one or more criteria for voting for an office, or other data of the election.

10. The system of claim 9, the criteria for voting for an office defining how many vote identifier servers must approve the personal identification information presented by the voter client before the voter client is authorized to register a voter public key.

11. The system of claim 9, the criteria for voting for an office defining how many registrar servers must approve the request for registration presented by the voter client before the voter client's request is approved.

12. The system of claim 8, the voter client configured to publish a decision on an election contest to the block chain database after receiving authorization within the system.

13. The system of claim 8, further configured to use a specific protocol to approve a voter client to submit the decision to the block chain database and disassociates the personal identifying information from the voter client decision for submission of the decision to the block chain database.

14. A method to document the identity of a user of a voter client to authorize the voter client to register a voter public key and for the voter client to vote in an election comprising:
capturing a picture by a webcam of the voter client of a user and of an identification of the user;
specifying by a voter identifier server which form of identification to accept;
sending a request for identity verification by the voter client to the voter identifier server;
determining by the voter identifier server whether the provided identification is valid and the identified user is authorized to vote;
indexing a physical address of the user specified by the identification against a geographic information system database by the voter identifier server;
certifying by the voter identifier server one or more contests for which the user is eligible to participate in based upon the indexing;
generating a blinded token by the voter client;
submitting the blinded token by the voter client to a registrar server;
validating by the registrar server that the voter client has been certified by the voter identifier server;
returning a blinded cryptographic signature on the blinded token to the voter client by the registrar server;
unblinding the blinded signature and blinded token by the voter client;
generating the voter public key after a random period of time and sending to the registrar server the unblinded signature, the unblinded token and the voter public key;
verifying the unblinded signature on the unblinded token by the registrar server to determine that it validated the voter client;
certifying by the registrar server that the voter public key is authorized to vote on the contests; and
publishing one or more election decisions to a block chain database by the voter client cryptographically signed by its voter public key.

15. The method of claim 14 further comprising:
disassociating the personal identification information from the voter public key by the random time delay.

16. The method of claim 14 further comprising:
generating and cryptographically signing a transaction by the voter client that revokes its v e public key;
signing the transaction by an election admin client;
signaling the transaction to the voter identifier server, the registrar server, the voter client, the election admin client and a block chain peer-to-peer network to ignore any votes cast by the voter public key before or after the transaction;
broadcasting the transaction to the block chain database by the election admin client; and
issuing a paper ballot by the election admin client.

17. The method of claim 16 further comprising:
invalidating the transaction once the paper ballot is issued and refusing to issue a second ballot for the voter client by the election admin client.

18. The method of claim 14 further comprising:
auditing the election decisions by inputting of the voter public key; and
receiving a counting and reporting of a total tally of the contests and the decisions published by the voter public key by the election admin client.
